(19) United States
(12) Patent Application Publication
(10) Pub. No.: US 2004/0023665 A1
(43) Pub. Date: Feb. 5, 2004

(54) Methods and apparatus for alternative mode monitoring

(75) Inventors: Christopher Martin Simmonds, Bristol (GB); Russell John Haines, Bristol (GB); Michael Philip Fitton, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/384,623

(22) Filed: Mar. 11, 2003

(30) Foreign Application Priority Data
Apr. 16, 2002 (GB) 0208692.4

(51) Int. Cl. H04Q 7/20

(52) U.S. Cl. 455/456.1; 455/422.1; 455/432.1; 455/446

(57) ABSTRACT

The invention relates to methods and apparatus for alternative mode monitoring in a communications system, particularly a wireless communications network.

A method of alternative mode monitoring in a communications system is described. The communications system includes a network communications access point and a terminal coupled to said access point for data communication between said terminal and said access point, one mode of said data communication comprising communicating data in tranches, transmission of a tranche of data from one of said access point and said terminal to the other of said access point and said terminal being acknowledged by an acknowledgement signal sent in reply. The method comprises suppressing said acknowledgement signal using said terminal, and reconfiguring said terminal to monitor an alternative mode of said data communication during a period when said acknowledgement signal would otherwise have been sent. Suppressing the acknowledgement signal allows reconfigurable operation of busy wireless data transfer systems with little disruption to network operation.

### FIELD OF THE INVENTION

This invention relates to methods and apparatus for alternative mode monitoring in a communications system, particularly a wireless communications network.

### BACKGROUND OF THE INVENTION

FIG. 1a shows a typical wireless LAN (Local Area Network) 10, as illustrated based on the Hiperlan/2 system. The network comprises a plurality of mobile terminals (MT) 12 each in radio communication with an access point (AP) 14 or base station of the network. The access points 14 are also in communication with a central controller (CC) 16 which in turn may have a link 18 to other networks, for example a fixed Ethernet-type local area network. In some instances, for example in a Hiperlan/2 network where there is no local access point, one of the mobile terminals 12 may take the role of an access point/central controller to allow a direct MT to MT link, illustratively shown by radio link 20.

In this specification particular reference will be made to the IEEE 802.11 and Hiperlan/2 wireless LAN systems but the invention is not restricted to these systems. Similarly although for convenience some of the terminology used in the Hiperlan/2 specification, such as “mobile terminal” and “access point” will be employed, this should not be taken to imply any limitation to the Hiperlan/2 system or to any particular form of access point (or base station) or mobile terminal.

Hiperlan/2 is a European standard for a 54 Mbps wireless network with security features, operating in the 5GHz band. IEEE 802.11 and, in particular, IEEE 802.11 a, is a US standard defining a different networking architecture, but also using the 5GHz band and providing data rates of up to 54 Mbps. The Hiperlan (High Performance Radio Local Area Network) type 2 standard is defined by a Data Link Control (DLC) Layer comprising basic data transport functions and a Radio Link Control (RLC) sublayer, a Packet based Convergence Layer comprising a common part definition and an Ethernet Service Specific Convergence Sublayer, a physical layer definition and a network management definition. For further details of Hiperlan/2 reference may be made to the following documents, which are hereby incorporated by reference: ETSI TS 101 761-1 (V1.3.1): “Broadband Radio Access Networks (BRAN); HIPERLAN Type 2; Data Link Control (DLC) Layer; Part 1: Basic Data Transport Functions”; ETSI TS 101 761-2 (V1.2.1): “Broadband Radio Access Networks (BRAN); HIPERLAN Type 2; Data Link Control (DLC) Layer; Part 2: Radio Link Control (RLC) sublayer”; ETSI TS 101 493-1 (V1.1.1): “Broadband Radio Access Networks (BRAN); HIPERLAN Type 2; Packet based Convergence Layer; Part 1: Common Part”; ETSI TS 101 493-2 (V1.2.1): “Broadband Radio Access Networks (BRAN); HIPERLAN Type 2; Packet based Convergence Layer; Part 2: Ethernet Service Specific Convergence Sublayer (SSCS)”; ETSI TS 101 475 (V1.2.2): “Broadband Radio Access Networks (BRAN); HIPERLAN Type 2; Physical (PHY) layer”; ETSI TS 101 762 (V1.1.1): “Broadband Radio Access Networks (BRAN); HIPERLAN Type 2; Network Management”. These documents are available from the ETSI website at www.etsi.org.

FIG. 1b shows an exemplary mobile terminal 100 and access point 150 for a Hiperlan/2 system incorporating, respectively, an OFDM (Orthogonal Frequency Division Multiplexed) transmitter and an OFDM receiver. In practice both the mobile terminal and access point will include both a transmitter and receiver (or transceiver) for bidirectional communications, although for simplicity this is not shown in FIG. 1b.

In the terminal 100 a data source 102 provides data to a baseband mapping unit 104, which optionally provides forward error correction coding and interleaving, and which outputs modulated symbols such as QAM symbols. The modulated symbols are provided to a multiplexer 108 which combines them with pilot symbols from a pilot symbol generator 106, which provides reference amplitudes and phases for frequency synchronisation and coherent detection in the receiver (in other arrangements differential detection may be employed). The combination of blocks 110 converts the senal data stream from multiplexer 108 to a plurality of parallel, reduced data rate streams, performs an IFFT on these data streams to provide an OFDM symbol, and then converts the multiple subcarriers of this OFDM symbol to a single serial data stream. This serial (digital) data stream is then converted to an analogue time-domain signal by digital-to-analogue converter 112, up-converted by up-converter 114, and after filtering and amplification (not shown) output from an antenna 116. Antenna 116 may comprise an omni-directional antenna, a sectorised antenna or an array antenna with beamforming.

The signal from antenna 116 of transmitter 100 is received by an antenna 152 of receiver 150 via a “channel” 118, typically comprising plurality of multipath components with different amplitudes and phases. The terminal mobility exacerbates the effects of multipath and for this reason error correction means are included in the terminal and access point.

The antenna 152 of receiver 150 is coupled to a down-converter 154 and to an analogue-to-digital converter 156. Blocks 158 then perform a serial-to-parallel conversion, FFT, and parallel-to-serial re-conversion, providing an output to demultiplexer 160, which separates the pilot symbol signal 162 from the data symbols. The data symbols then demodulated and de-mapped by base-band de-mapping unit 164 to provide a detected data output 166. Broadly speaking the receiver 150 is a mirror image of the transmitter 100. The transmitter and receiver may be combined to form an OFDM transceiver.

The receiver and transmitter, front (rf) ends will generally be implemented in hardware whilst the receiver and transmitter processing sections and error correction will often be implemented in “software”, for example, using ASICs, FPGAs and/or one or more DSP (digital signal processor) chips with appropriate control code. However the skilled person will recognise that all the functions of the transmitter and/or receiver could be performed in hardware. The exact point at which the signal is digitised in a software radio will generally depend upon a cost/complexity/power consumption trade-off, as well as upon the availability of suitable high speed analogue/digital converters and processors.

FIG. 1c shows further details of the mobile terminal 100. The radio interface 101 is indicated generically and is in data and control communication with a terminal processor 180 which, inter alia, acts as the data source 102 described with reference to FIG. 1b. The terminal processor 180 is also in communication with working memory 182 and program memory 184 as well as a Man Machine Interface (MMI) 186 for user control and for data input and output.

FIG. 1d shows program memory 184 in more detail. In a conventional fashion this includes application layer code 186, transport layer code 188, for example comprising IP (Internet Protocol) or ATM (Asynchronous Transfer Mode) code, and Data Link Control (DLC) layer code 190. The DLC code 190 comprises Logical Link Control (LLC) code 192 and Medium Access Control (MAC) or Radio Link Control (RLC) code 194. As the skilled person will appreciate these various layers of code sit above the physical wireless link layer. The skilled person will also understand that the diagram of Figure id is a simplification of the code in program memory 184.

Data transmission is also becoming increasing important within mobile phone networks, and in particular within so-called 2.5G and 3G (Third Generation) networks. These 2.5G and 3G networks, are encompassed by the International Mobile Telecommunications IMT-2000 standard (www.ituint), hereby incorporated by reference. Third generation technology uses CDMA (Code Division Multiple Access) for communicating across the radio interface between a mobile station and a base station and the IMT-2000 standard contemplates three main modes of operation, W-CDMA (Wide band CDMA) direct spread FDD (Frequency Division Duplex) in Europe and Japan, CDMA-2000 multicarrier FDD for the USA, and TD-CDMA (Time Division Duplex CDMA) and TD-SCDMA (Time Division Synchronous CDMA) for China.

Collectively the radio access portion of a 3G network is referred to as UTRAN (Universal Terrestrial Radio Access Network) and a network comprising UTRAN access networks is known as a UMTS (Universal Mobile Telecommunications System) network. The UMTS system is the subject of standards produced by the Third Generation Partnership Project (3GPP, 3GPP2), technical specifications for which can be found at www.3gpp.org. These standards include Technical Specifications 23.101, which describes a general UMTS architecture, and 25.101 which describes user and radio transmission and reception (FDD) versions 4.0.0 and 3.2.2 respectively, which are also hereby incorporated by reference.

In some communications networks, such as wireless LAN's or digital mobile phone networks, more than one communications service (transmission or reception) or mode may be available to some mobile terminals. Similarly data transmission or reception communications services supported by different networks may be available in certain terminal locations. For example, it is desirable to be able to provide mobile communications terminals capable of receiving both 2.5G/3G mobile phone signals and also legacy 2G signals, to provide improved flexibility and coverage and to facilitate upgrading. In a WLAN there may be similar requirements or different modes of operation may be provided, for example, to support different bandwidths in order to help reduce the demand for bandwidth.

As used herein, mode refers, but is not limited, to a protocol or standard or frequency. Multi-mode operation can be implemented using a software-defined radio system. This allows a terminal to reconfigure to support a plurality of operational modes or standards or local telecommunications services. However it will be appreciated that in order to perform such reconfiguration the software defined radio system must monitor the local telecommunications services or modes, to determine their availability and often other parameters such as signal strength, quality of service and the like.

To enable a mobile terminal to monitor more than one local service or mode a plurality of simultaneously operable transceiver chains may be provided. However this is complex and expensive. The problems associated with multiple transceiver chains can be overcome by using a reconfigurable software defined radio system. Such a system is able to reconfigure from a current mode of operation to an alternative mode of interest and perform a number of measurements before returning to its original operational mode. This process is outlined in FIG. 2.

FIG. 2 shows a flow chart 200 illustrating the stages in an alternative mode monitoring procedure. The cycle begins at step 202 in an initial or current mode from which the terminal reconfigures, at step 204, to a new mode. The terminal then, at step 206 tunes to an appropriate frequency band and synchronises to a signal in the new mode. Once synchronisation is complete, signal level and quality of service measurements are made at step 208 before the terminal reconfigures back to the initial or current mode at step 210, tuning back to the current frequency and re-synchronising to the current mode at step 212. The cycle then loops back to step 202.

This momentary switching from the current mode to an alternative mode and then back should ideally be accomplished without disruption to any of the current mode services or applications supported by the terminal, and in particular without loss of data. One possible approach is to rely on the natural gaps in GSM, UMTS and Hiperlan 2 communications structures. However a problem with this is that in some modes of operation of these systems no such gaps exist or the gaps are too short to permit alternative mode monitoring without service disruption. The problem is particularly acute with high rate, low latency data transfers such as audio and video streaming.

FIG. 3 shows an example of a Media Access Control (MAC) frame 300 of a packet data communications system including preamble sequences. The MAC frame includes a broadcast channel (BCH) burst 302 followed by a frame channel (FCH) burst and an access feedback channel (ACH) burst (not shown), a down-link (DL) burst 308, an uplink (UL) burst 310, an (optional), direct link (DiL) burst 312, and a random access (RCH) burst 314. It can be seen that since an MAC frame lasts 2ms the alternative mode should preferably be monitored for 2 ms and, in practice the reconfiguring and re-tuning steps 204, 206, 210 and 212 of FIG. 2 may together require as much as 1 ms more.

One important problem arises in the context of alternative mode monitoring during operation of the HIPERLAN2 system in ‘ACTIVE’ mode rather than ‘IDLE’ mode. In this mode, nearly the entire time within the frame may be taken up with data transfer and thus the only period available for alternative mode monitoring is the random access phase, which can be as short as 60 μs. This could be too short for adequate estimation of an alternative mode of operation.

A terminal might wish to reconfigure to another mode for a number of reasons. One reason is because a higher data rate or Quality of Service (QoS) has been requested during a current communications/data transaction, one that cannot be supported by the current mode, or is unavailable to that mode. An example is upgrading from audio to video streaming. Another reason is because the QoS of the current link may have degraded and continued support of the required application or service cannot be maintained in the current mode. That is to say, handover within the current mode is unsuitable or unavailable and a better alternative communications link must be sought. Either of these reasons is likely to compound the problem of finding suitable periods in which to identify an alternative mode of operation.

### SUMMARY OF THE INVENTION

According to the present invention there is therefore provided a method of alternative mode monitoring in a communications system, the communications system including a network communications access point and a terminal coupled to said access point for data communication between said terminal and said access point, one mode of said data communication comprising communicating data in tranches, transmission of a tranche of data from one of said access point and said terminal to the other of said access point and said terminal being acknowledged by an acknowledgement signal sent in reply, the method comprising suppressing said acknowledgement signal using said terminal, and reconfiguring said terminal to monitor an alternative mode of said data communication during a period when said acknowledgement signal would otherwise have been sent.

Preferably the communications system comprises a packet data communications system such as a digital mobile phone network or wireless LAN or other mobile radio network. The access point may comprise an access point or base station of a wireless LAN or WAN (Wide Area Network), or a Node B of a 2.5G or 3G mobile phone network, or another mobile terminal, for example in a Hiperlan 2 network, or some other mobile radio base station. The terminal may comprise any mobile radio communications terminal such as a digital mobile phone or a PDA (Personal Digital Assistant) or a conventional computer with wireless communications.

This method and the related methods described below may be employed for monitoring two or more operating modes of a single network or, more likely, to provide a terminal or mobile phone capable of monitoring two different networks, such as a GSM or UMTS network and an IEEE802.11 or Hiperlan/2 network.

By suppressing the acknowledgement signal the effect of a lost or corrupted data packet is simulated and thus the communications system implements conventional error handling/correcting procedures. These may comprise, for example, ignoring a missing packet or automatically requesting retransmission of the missing data if the acknowledgement signal is not received within a pre-determined time interval, typically a window allowed for confirmation correct receipt of the data. Thus advantage can be taken of existing protocols and operating procedures within the communications system to generate a time window during which alternative mode monitoring may take place. This allows software defined radios that have a “busy” mode of operation, which might otherwise prevent them from being able to quickly allocate time to monitor other modes of operation, to reconfigure. For example the technique may be applied to WLAN systems, such as IEEE 802.11, in which a positive “ACK” (acknowledge) requirement is specified for unicast data transfer, and in which when such an acknowledgement signal is not received the transmission is repeated until acknowledgement is finally received. However it will be recognised that applications of the invention are not limited to such systems.

Embodiments of the invention enable time-allocation for monitoring alternative modes of operation for reconfigurable radio systems by using forced packet loss. Embodiments are applicable to any wireless data transfer standard using a retransmission method normally used to recover lost or corrupted received data, such as automatic repeat request (ARQ). Thus ARQ mechanisms within Hiperlan 2 and/or IEEE 802.11 may be exploited. There is no requirement for a separate transceiver chain, although the transceiver chain may need to be reconfigurable to provide multi-mode operation. The methods also provide little disruption to normal operation of the current data transfer mode and may be implemented such that they are relatively transparent to operation of the network.

In another aspect the invention provides a method of operating a reconfigurable radio packet data communications tenninal, the method comprising: receiving at least one packet of data from a data transmitter using a first mode of operation of said terminal; reconfiguring said terminal to a second mode of operation; operating said terminal in said second mode of operation; reconfiguring said terminal back to said first mode of operation; and transmitting an acknowledgement signal for said at least one packet of data to said data transmitter.

This method provides similar advantages to those described above. The reconfiguring to the second mode of operation may be triggered or initiated by receiving of the at least one packet of data. Again the acknowledgement signal may be suppressed, that is not sent or a not acknowledged (NAK) response sent, until after reconfiguration back to the first mode of operation. The method may provide a delay of more than a single retransmission interval and may be employed with single packets of data or groups of packets of data, the latter where, for example, a single acknowledgement signal is used to acknowledge receipt of multiple packets of data.

In a preferred embodiment the at least one packet of data received in the first mode of operation is checked for validity and/or stored for future use. This helps prevent loss of data. However where the quality of service in the first mode of operation is low it may be preferable simply to ignore the at least one packet of data to provide more time for alternative mode monitoring.

In embodiments of the method a timer may be employed to ensure that the acknowledgement signal is transmitted in time to acknowledge a retransmission, for example a first retransmission, of the at least one packet of data from the data transmitter.

In another aspect the invention provides a method of operating a reconfigurable radio packet data communications terminal, the method comprising: operating said terminal in a first mode; reconfiguring said terminal to a second mode of operation; operating said terminal in said second mode of operation; reconfiguring said terminal back to said first mode of operation; and wherein said operating in said second mode is limited to substantially no more than twice a time allowed for valid acknowledgement of a reception of a packet data communication by said terminal less a time taken for said reconfiguring of said terminal from said first mode to said second mode and back.

In a further aspect the invention provides a method of using a reconfigurable terminal of a wireless packet data communications network to create a time window to enable alternative mode monitoring, the method comprising omitting to transmit from the terminal an acknowledgement signal for a packet data communication to force retransmission of the packet data communication, to create said time window for reconfiguring said terminal to enable said alternative mode monitoring.

In a related aspect the invention also provides a method of operating a reconfigurable radio packet data communications terminal, the method comprising: sending at least one first packet of data from the terminal to a data receiver using a first mode of operation of the terminal; reconfiguring said terminal to a second mode of operation; operating said terminal in said second mode of operation; reconfiguring said terminal back to said first mode of operation; and sending at least one second packet of data from the terminal to said data receiver using said first mode of operation; and timing said operating such that said at least one first packet and said at least one second packet are sent with an interval substantially no greater that a time allowed for acknowledgement of valid reception of said at least one first packet of data.

In embodiments the timing is such that the at least one second packet is sent with an interval approximately corresponding to that expected by the access point (or terminal) for a retransmission of the at least one first packet of data, preferably the first retransmission.

In a further related aspect the invention provides a method of using a reconfigurable terminal of a wireless packet data communications network to create a time window to enable alternative mode monitoring, the method comprising omitting to transmit a packet data communication from the terminal to create said time window for reconfiguring said terminal to enable said alternative mode monitoring.

The invention also provides a terminal operating in accordance with the above-described method.

The invention further provides processor control code, and a carrier medium carrying the code, to implement the above described methods and terminal functions. This code may comprise conventional program code or microcode or code for setting up or controlling an ASIC or FPGA. The carrier may comprise a storage medium such as a hard or floppy disk, CD- or DVD-ROM or programmed memory such as read-only memory (firmware), or a data carrier such as an optical or electrical signal carrier. As the skilled person will appreciate the code may be distributed between a plurality of coupled components in communication with one another.

### BRIEF DESCRIPTION OF THE DRAWINGS

These and other aspects of the invention will now be further described, by way of example only with reference to the accompanying figures in which:

FIGS. 1a to 1d show, respectively, a wireless local area network, a mobile terminal and access point, a block diagram of a mobile terminal, and program memory for a mobile terminal;

FIG. 2 shows a flow diagram of an alternative mode monitoring procedure;

FIG. 3 shows a medium access control frame of a Hiperlan 2 network;

FIG. 4 shows a procedure for providing an alternative mode monitoring window in a downlink phase of a packet data network;

FIG. 5 shows a procedure for providing an alternative mode monitoring window in an uplink phase of a packet data network; and

FIG. 6 shows program memory for a terminal according to an embodiment of the present invention.

### DETAILED DESCRIPTION

Broadly speaking we will describe a method to support alternative mode monitoring for a terminal that is currently operating in a dedicated data transfer mode but is capable of multi-mode operation. For simplification, we will assume that a WLAN Access Point (AP) or designated Central Controller (CC) is not able to offer any support for alternative mode monitoring and so must appear to see a substantially normal operation and exchange of data packets with the mobile terminal (MT). That is to say it will be assumed that no time allocation is made by the AP between data transactions for MT reconfiguration to an alternative mode of operation.

According to the method the MT identifies the need to search for alternative modes of operation whilst operating as a “busy” Time Division Duplex (TDD) WLAN, with no immediate “IDLE” periods in which to otherwise perform the search, for example during real-time video streaming. The search for alternative modes of operation is preferably performed such that it is relatively transparent to other parts of the network.

The operation may be instantiated in several ways. In receive mode or the downlink phase 308 of FIG. 3, the MT can make available a measurement period through the forced or perceived loss of data. Thus it will appear to have failed to receive a valid burst of data, or packet (say), as if the loss or data corruption occurred over the channel. The actual data packet has been received intact, is valid, and can be stored for later use.

This embodiment of the method uses an error correction or handling protocol operating on the WLAN system, which retransmits the missing data burst at an appropriate interval defined by the protocol. For example following a failure to receive an acknowledgement (ACK) at the AP the AP may retransmit the “missing” data after a defined period. As the MT does not need to receive the retransmitted this time period or window can be used to reconfigure and make appropriate measurements of the alternative mode of operation. The terminal preferably reconfigures back to its current mode within a time-period specified by the system automatic repeat request (ARQ) timers.

Alternatively, the packet (or packets) may be ignored, in effect discarded. The MT may then reconfigure during the sending time of the packet, with an appropriate ‘not acknowledged’ (NAK) or no response to the AP as before.

These methods can be applied equally to simulate the loss of multiple packets or cells, if required. Preferably, however, the method is applied so that the overall operation of the system performance is not adversely affected, as this would otherwise negate the relative transparency of such a technique.

Likewise for the uplink phase 310 of FIG. 3, or with the MT in transmission mode, the method can be implemented by not sending a packet of data from the terminal, again using this time to reconfigure and monitor other modes.

The direct link phase 312 of FIG. 3, which is a more ad hoc network mode, can be regarded much as one of the previous two phases, but with one of the MT's acting as a CC without an AP present.

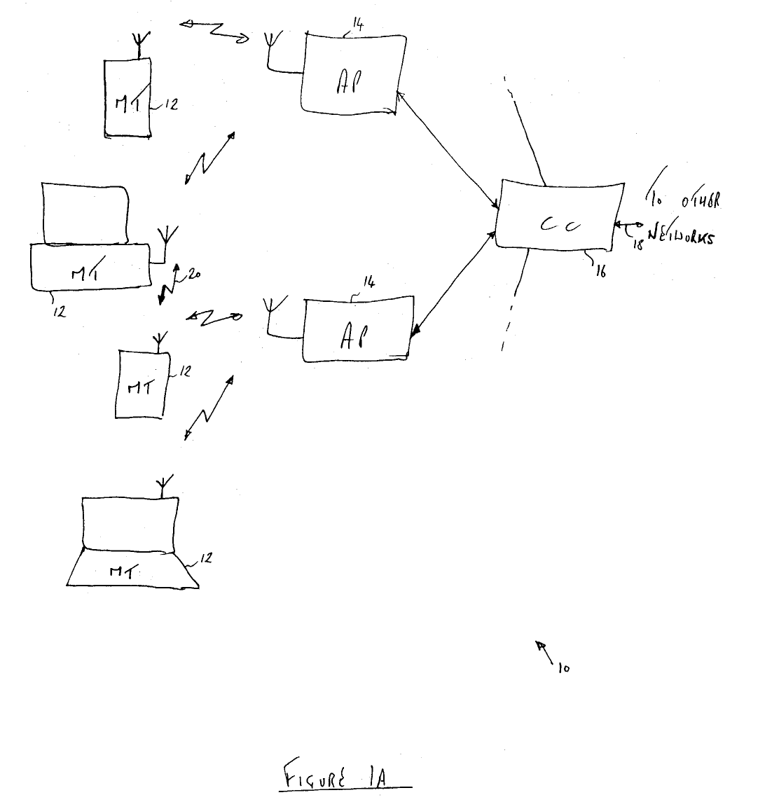

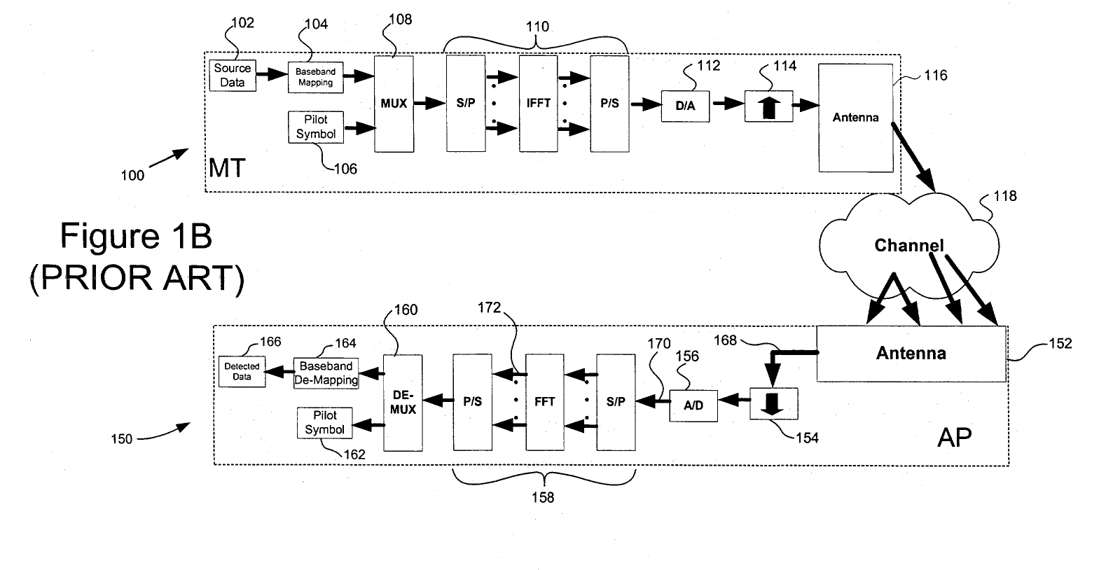

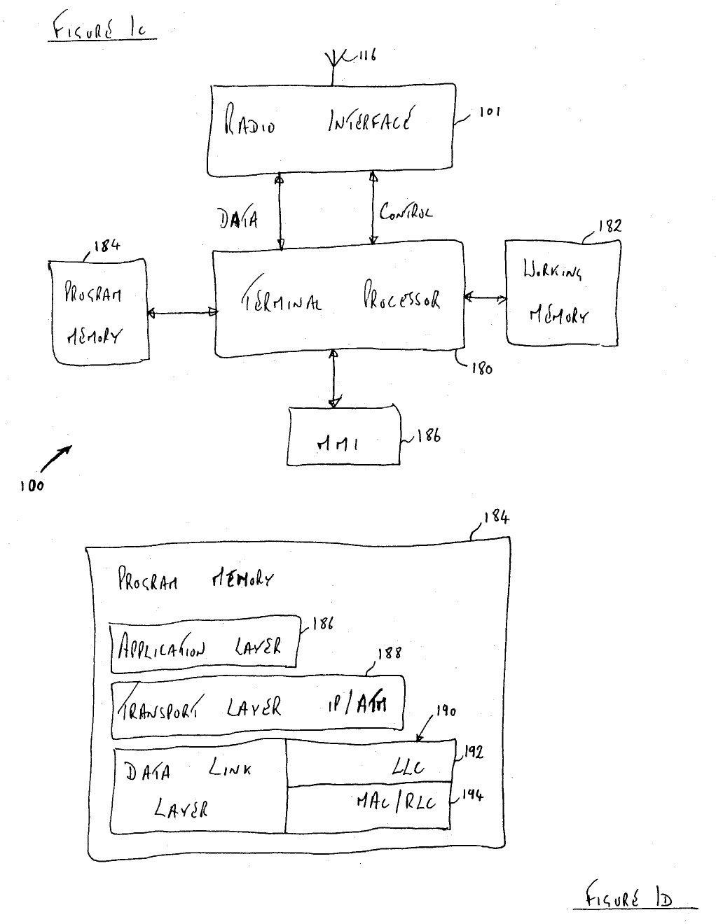

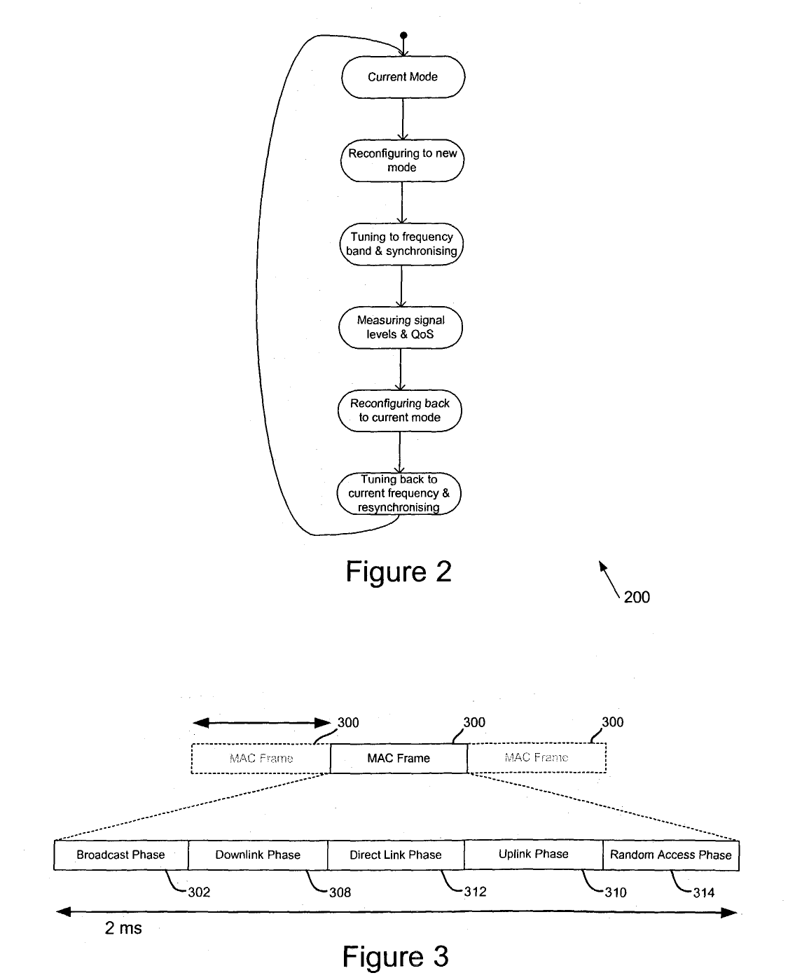

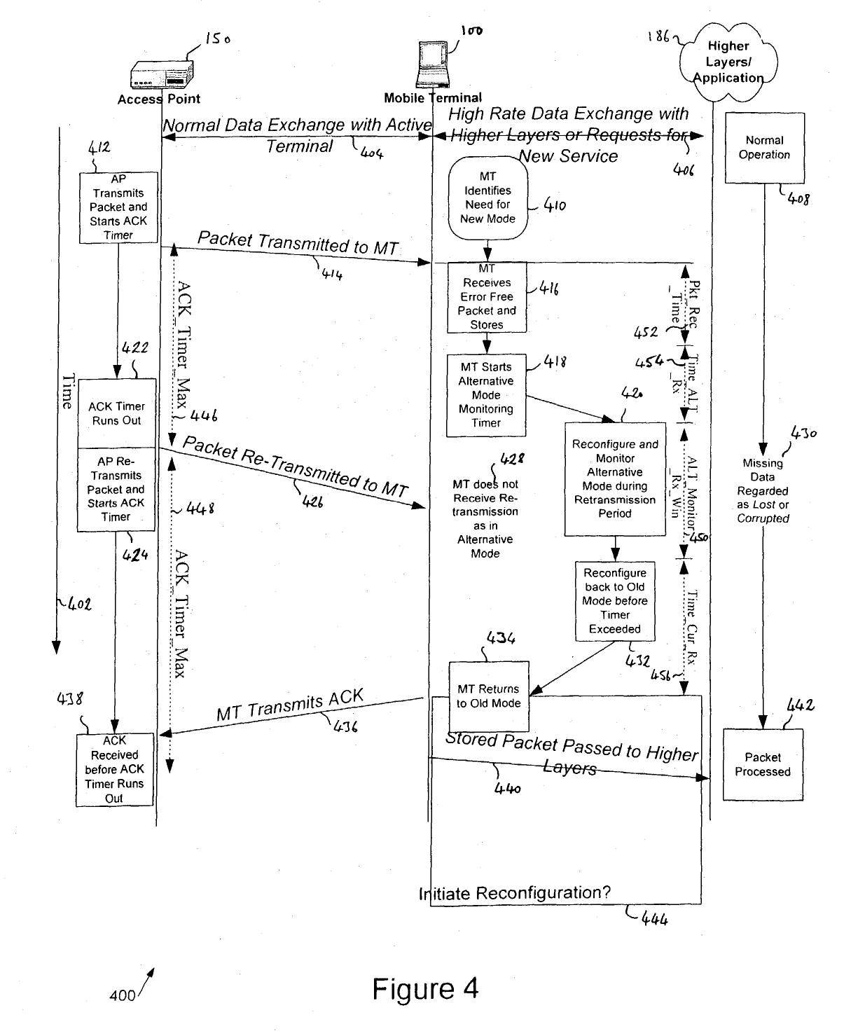

Referring now to FIG. 4, this shows steps in a method 400 for obtaining a reconfiguration and alternative mode monitoring window in a downlink phase of a wireless network such as a Hiperlan 2 network. In FIG. 4 a time axis 402 runs vertically, increasing in a downward direction. Initially higher layer 188 and application layer 186 code is running on mobile terminal 100 to provide normal data exchange services 404 between the terminal 100 and an access point 150. In the illustrated example these are high data rate exchange services and within the terminal data is exchanged between the layers of program code in program memory 184 of FIG. 1d as shown by arrows 406. Thus these higher and application layers operate normally as indicated by box 408.

The method which will be described typically, but not necessarily, operates at the data link layer 190, in response to a request for a new service or a deterioration in quality of a current service. Additionally or alternatively however the method may be running as a background task to enable user mode switching. Thus, at step 410 the mobile terminal identifies a need for a new mode of operation.

The user data transport function is fed with user data packets from higher layers via the User Service Access Point (U-SAP). This contains the Error Correction (EC) which, in this embodiment, is based on an Automatic Repeat Request (ARQ) scheme. Additional forward error correction and the EC are complementary but do not need to collaborate.

Broadly speaking, FIG. 4 shows the operation of the perceived data loss for the example case of a lost packet in the downlink to the MT. In this simple example, it is assumed that the transmission window is set to a size of 1, that is each packet is acknowledged before sending the next, resulting in an unacknowledged packet being immediately resent after its loss has been identified. For the purposes of illustration it is also assumed that the system will only tolerate a single packet loss, although in other embodiments consecutive or multiple packet (simulated) losses may be employed.

The time period, referred to as the Alternative Mode Monitoring Window (ALT_Monitor_Rx_Win) (Equation 1), should not be exceeded if normal operation of the system is to be observed by higher layers and other parts of the network. In the example shown, this time period should not exceed the maximum time allowed to acknowledge receipt of the packet (ACK_Timer_Max) before EC via ARQ, less the time taken to accurately receive the data (Pkt_Rec_Time) and reconfigure to the alternative mode of interest (Time_Alt_Rx) and back to the current mode (Time_Cur_Rx).

ALT_Monitor_Rx_Win<=2*ACK_Timer_Max−(Pkt_Rec_Time+Time_Alt_Rx+Time_Cur_Rx) Equation 1

In some embodiments the reception of the packet may be ignored altogether and recovery of the data left to ARQ. In such embodiments (again assuming single packet loss) the time allocated to this operation is given by Equation 2. However although these methods maximises the time allotted to the alternative mode monitoring, they jeopardise the successful reception of the data through ARQ.

Consider a case where the reconfiguration requirement is due to poor link quality. The first method (receiving, optionally checking/validating and, optionally storing the packet before reconfiguring) can guarantee that the data has been received correctly before monitoring other modes. However, this can delay the monitoring process and any subsequent move to another mode before the link quality becomes critical. The second method (ignoring the packet) would be more likely to find a new mode of operation before the link deteriorated too far. Selection between these options may be made by the terminal manufacturer, or may be a software setting, or an option may be selected based on the current/alternative mode or upon some other local operating conditions.

ALT_Monitor_Rx_Win<=2*ACK_Timer_Max−(Time_Alt_Rx+Time_Cur_Rx) Equation 2

If the mode monitoring delay is too long there may be adverse effects to the operation of higher layers, in particular for TCP—Transmission Control Protocol, in WLAN systems. However, as the packet delays can be highly variable often this does not cause any problems for delays of the order of a few 10's of milliseconds.

After returning to the initial mode of operation, based on the measurements performed the terminal may decide to reconfigure ‘permanently’ or handover to the alternative mode.

Referring in more detail to FIG. 4, at step 412 the AP 150 transmits a packet 414 to the mobile terminal 100 and starts a timer to define a period for receiving an acknowledgement of receipt back from the terminal. At step 416 the mobile terminal 100 receives the error free packet and stores the packet, for example in working memory 182. The mobile terminal then, at step 418, starts an alternative mode monitoring (AMM) timer and, at step 420, reconfigures the mobile terminal 100 for alternative mode monitoring.

In the meantime at step 422, the access point acknowledgement timer expires and, at step 424, the AP 150 retransmits 426 the packet and restarts the acknowledgement timer. However, as indicated by block 428, the retransmitted packet is not received by mobile terminal 100 as it has been configured for operation in its alternative mode. The alternative mode monitoring 420 takes place during the packet retransmission period 426. The packet transmitted to the mobile terminal during period 414 is regarded as lost or corrupted by AP 150, as indicated by block 430.

At step 432 mobile terminal 100 reconfigures back to its initial mode before the AMM timer is exceeded or times out and thus, at step 434, the mobile terminal returns to its initial mode. Having returned to its initial mode the mobile terminal 100 transmits 436 an acknowledgement signal back to AP 150 which the access point receives, at step 438, before the acknowledgement timer started at step 424 for the retransmitted packet expires. The mobile terminal, in the meantime, retrieves the packet stored at step 416 and passes 440 this up to higher layers within the system where the packet is processed 442. Following the mobile terminal's return to its initial mode a decision 444 is also made as to whether or not to initiate reconfiguration to the alternative mode.

It can be seen from inspection of FIG. 4 that the interval between the initial packet transmission 414 and the acknowledgement timer expiry for the packet retransmission 426 (at step 438) is defined by two AP acknowledgement time intervals 446 and 448. These define the period within which the mobile terminal acknowledgement signal transmission 436 should arrive at the AP. This in turn defines an alternative mode monitoring time window 450 since, in the embodiment of FIG. 4, the duration 450 of this time window plus a packet receive time 452 (for step 416) plus an alternative mode reconfigure (receive) time 454 (for step 418) plus an initial mode reconfigure (receive) time 456 (for step 432) must be less than the sum of the two acknowledgement interval times 446 and 448.

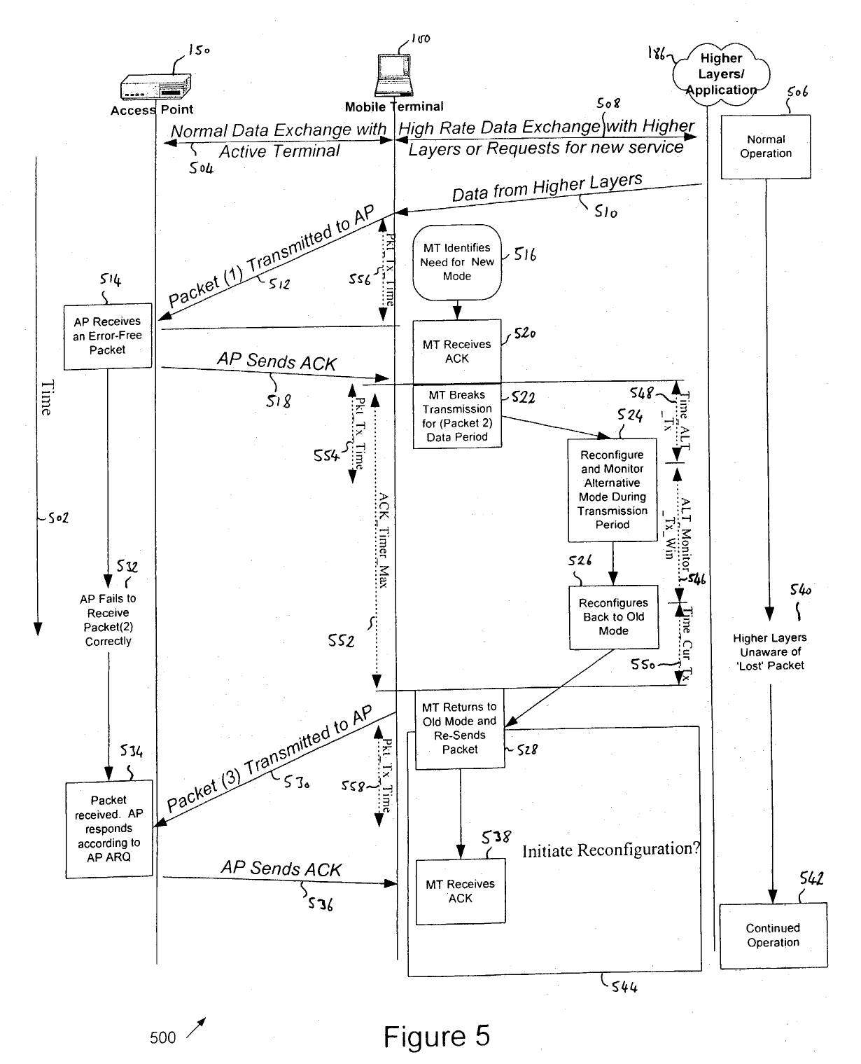

FIG. 5 shows an embodiment 500 of a method for providing a window for terminal reconfiguration and alternative mode monitoring during an uplink phase of a network communication. Thus in FIG. 5 the data transmission direction is from the mobile terminal 100 to the access point 150. In the case of Hiperlan/2 this embodiment of the method may be employed during the uplink phase 310 of the MAC frame shown in FIG. 3.

Broadly speaking, in FIG. 5 the second packet in the transmission sequence is not sent and the first and third packets are sent with a gap between them less than or equal to the expected acknowledgment window (ACK_Timer_Max). This window is greater than the time for transmission of the ‘real’ data (Pkt_Tx_Time). With the same assumptions as outlined above in relation to FIG. 4 the third packet preferably comprises a retransmission of the data from the second packet, under ARQ with a window size of 1. The time available for alternative mode monitoring in the method of FIG. 5 is given by Equation 3 and, as can be seen, is smaller than for the downlink case of FIG. 4.

ALT_Monitor_Tx_Win<=ACK_Timer_Max−(Time_Alt_Tx+Time_Cur_Tx) Equation 3

Again, on returning to the initial or “current” mode of operation, MT 100 may decide to reconfigure to the monitored mode.

In FIG. 5, as with FIG. 4, a time axis 502 increases in the downwards direction. Initially there is normal or current mode data exchange 504 between MT 100 and AP 150 and MT 100 operates normally 506. Thus, as shown, there is a high data rate exchange 508 between program layers within the terminal, and optionally requests for one or more new services or modes. More particularly in the embodiment of FIG. 5 data is passed 510 down through the layers within MT 100 and a first packet is transmitted 512 from MT 100 to AP 150, where it is received 514 error-free.

At step 516 MT 100 identifies the need, or potential need, for a new mode of operation. Following reception of the first packet at step 514 the AP 150 sends an acknowledgement 518 to the mobile terminal, which is received at step 520, confirming correct receipt of the first transmitted packet. The mobile terminal then breaks transmission to AP 150, at step 522, for the second packet (packet 2) data period. Then once the mobile terminal knows that AP 150 received packet 1 correctly it reconfigures 524 to an alternative mode and begins monitoring this mode.

After a period the terminal 100 reconfigures 526 back to its initial mode and then, at step 528, resends the second data packet to AP 150. This second packet is transmitted 530 to the AP during a third packet interval. During the second packet interval the AP failed 532 to receive the second packet correctly, in effect assuming this was because the packet was lost or corrupted. At step 534 the AP correctly receives the second packet during the third packet interval and responds with an acknowledgement 536 to the mobile terminal 100, in accordance with an AP ARQ (Automatic Repeat Request) protocol. The MT 100 receives this acknowledgement signal at step 538 and the higher layers in the mobile terminal are thus unaware 540 of the “lost” packet so that normal operation may be continued 542. Following reconfiguration back to its initial mode MT 100 also makes a decision 544 as to whether or not to initiate reconfiguration to the alternative mode.

The time taken by the alternative mode monitoring is the sum of an alternative mode monitoring window 546, an alternate mode reconfiguration (transmit) time 548 and an alternate mode reconfigure (transmit) time 550. As can be seen from inspection of FIG. 5 this alternative mode monitoring should preferably be completed within an acknowledgement time interval 552. Time interval 552 has an end point defined by the time at which mobile terminal 100 would normally have expected to receive an acknowledgement from AP 150 of receipt of the packet following transmission 512 of packet 1. The start point of time interval 552 may, as indicated in FIG. 5, be defined by the start of a packet to transmission period 554 or it may be defined by the end of a packet to transmission period 554, that is when MT 100 would have expected AP 150 to have received the second packet (this latter alternative is not illustrated in FIG. 5). Other packet transmission times 556, 558 are illustrated in FIG. 5 to show when, in relation to these, acknowledgements from the AP are normally received at the MT.

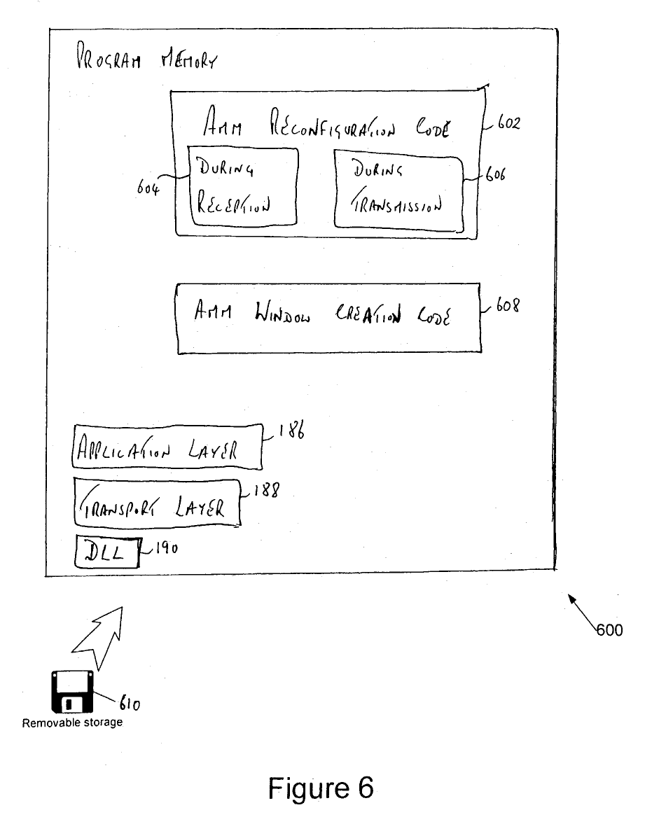

Referring to FIG. 6 this shows program memory 600 for a mobile terminal configured to operate in accordance with a previously described method. As previously described with reference to FIG. 1d, program memory 600 includes application layer code 186, transport layer code 188 and data link layer code 190. Program memory 600 further includes alternative mode monitoring reconfiguration code 602 comprising code 604 for AMM reconfiguration during reception, as described with reference to FIG. 4, and AMM code 606 for reconfiguration during transmission, as described with reference to FIG. 5. Program memory 600 further includes AMM window creation code 608 to implement the simulated packet loss procedures of FIG. 4 and/or FIG. 5, as described above. The AMM reconfiguration code 602 and AMM window creation code 608 is preferably implemented at the DLL layer 190 although as the skilled person will recognise, it may also be implemented in other layers, or between layers, or spanning more than one layer. The AMM code 602, 608, and other code in program memory 600, may be provided on a removable storage medium such as disk 610 or non-volatile memory.

The above-described methods allow reconfigurable operation of busy wireless data transfer systems with little disruption to network operation, even under current standards. Thus the methods need not conflict with conformance testing and interworking with legacy equipment. Although the overall performance across a single link may be reduced the methods nonetheless do allow further modes of operation to be examined during times of high or lengthy data transfer. Thus for wireless systems operating under adverse channel conditions methods such as those described may provide the only solution to seeking alternative modes of operation prior to loss of the link altogether, with minimal disruption to the current mode of operation and to services maintained across it.

The above techniques although described with reference to Hiperlan/2, are also suited to other WLAN applications, for example IEEE 802.11-based systems. Thus the positive ‘ACK’ for unicast data transfer in IEEE 802.11 will cope with the terminal not responding, by repeating the transmission until it is finally received. There is therefore no hard time constraint on the length of the monitoring activity, other than to try and avoid missing broadcast packets from the AP whilst configured to the alternative mode.

The foregoing description may be better understood by reference to the following glossary of terms, which is included merely by way of assistance and which should not be taken to limit the interpretation of any terms used in this specification.

| Term | Description |
|---|---|
| ACK | Terminal acknowledgement on receiving a valid burst |
| | (packet or cell) of data |
| AP | Access point or RLAN/WLAN or other base station |
| ARQ | Automatic repeat request protocol for re-transmission |
| | of lost or corrupted data bursts |
| ATM | Asynchronous transfer mode, cell-based transmission |
| | scheme |
| CC | Central Controller — provides control functionality |
| | equivalent to that of an AP but is not necessarily attached |
| | to a fixed network. This term is normally used if central |
| | controller and MT functionality are located in a single |
| | device. It mostly involves direct mode communication in |
| | Hiperlan/2, but is used here to indicate any R/WLAN |
| | coordinating device |
| DLC | Data Link Control protocol layer; Hiperlan/2 operates a |
| | user or connection oriented protocol. A DLC connection |
| | carries control data and is identified by a DLC |
| | connection identifier. A connection has a set of |
| | properties for the transfer of data agreed |
| | upon between the MT and the AP or between MT's |
| EC | and a CC Error correction |
| GSM | 2^{nd} generation telecommunications system |
| HIPERLAN2 | High Performance Radio Local Area Network — |
| | European (ETSI) family of Wideband RLAN's of which |
| | Hiperlan/2 is the 5GHz OFDM system. |
| HiSWANa | High Speed Wireless Access Network — the Japanese |
| | standard for 5GHz Wireless Access System |
| LLC | Link layer control |
| MAC | Medium access control protocol layer — includes the |
| | DLC and RLC |
| MT | Mobile terminal |
| NAK | Not acknowledged response sent when a packet or cell of |
| | data is received but is corrupted |
| PHY | Physical layer — lowest protocol layer |
| QoS | Quality of service |
| RLAN | Radio local area network, same as WLAN |
| RLC | Radio link control protocol layer — control plane of |
| | the DLC which offers transport services for the radio |
| | resource control, association control function and the |
| | DLC user connection control |
| SDR | Software defined radio system, capable of reconfiguring |
| | to a number of different operating modes through |
| | software control of its functionality |
| TCP/IP | Transmission (Transport) Control Protocol/Internet |
| | Protocol — a combined Transport Layer and Network |
| | Layer set of protocols developed for military networks |
| | and popularized when included in many versions |
| | of Unix. |
| TDD | Time division duplex |
| U-SAP | User service access point |
| UMTS | 3^{rd} generation telecommunications system |
| WLAN | Wireless local area network; no different to RLAN. |

No doubt many other effective alternatives will occur to the skilled person. For example although embodiments of the methods have been described with reference to a single alternative mode of operation the skilled will recognise that variants of the methods may be used to monitor a plurality of alternative modes, for example in sequence. The invention is not limited in its application to wireless local area networks or digital mobile phone networks but may also be employed in private mobile radio networks such as TETRA, Radio Local Loop (RLL) networks, and other wireless data networks such as optical networks.

It will be understood that the invention is not limited to the described embodiments and encompasses modifications apparent to those skilled in the art lying within the spirit and scope of the claims appended hereto.

We claim:

1. A method of alternative mode monitoring in a communications system, the communications system including a network communications access point and a terminal coupled to said access point for data communication between said terminal and said access point, one mode of said data communication comprising communicating data in tranches, transmission of a tranche of data from one of said access point and said terminal to the other of said access point and said terminal being acknowledged by an acknowledgement signal sent in reply, the method comprising suppressing said acknowledgement signal using said terminal, and reconfiguring said terminal to monitor an alternative mode of said data communication during a period when said acknowledgement signal would otherwise have been sent.

2. A method as claimed in claim 1 wherein said transmission of a tranche of data comprises transmission from said access point to said terminal, wherein said suppressing of said acknowledgement signal causes retransmission of said tranche of data from said access point to said terminal, and wherein said alternative mode monitoring takes place at least partially during a period of said data re-transmission.

3. A method as claimed in claim 2 wherein said suppressing comprises sending a not acknowledged signal from said terminal to said access point.

4. A method as claimed in claim 1 wherein said transmission of a tranche of data comprises transmission from said terminal to said access point and wherein said suppressing using said terminal comprises omitting to transmit a said tranche of data from said terminal to said access point.

5. A method as claimed in claim 4 wherein said alternative mode monitoring takes place at least partially during a period when said omitted tranche of data would otherwise have been transmitted.

6. A method as claimed in claim 1 wherein said communications system comprises a mobile wireless communications system and wherein said data communication comprises radio data communication.

7. A method as claimed in claim 6 wherein said communications system comprises a wireless local area network.

8. A method of operating a reconfigurable radio packet data communications terminal, the method comprising:
receiving at least one packet of data from a data transmitter using a first mode of operation of said terminal;
reconfiguring said terminal to a second mode of operation;
operating said terminal in said second mode of operation;
reconfiguring said terminal back to said first mode of operation; and
transmitting an acknowledgement signal for said at least one packet of data to said data transmitter.

9. A method as claimed in claim 8 further comprising timing said operating such that said acknowledgement signal transmitting is in time to acknowledge a retransmission of said at least one packet of data from said data transmitter.

10. A method as claimed in claim 9 further comprising setting a timer to perform said timing following receipt of said at least one packet of data.

11. A method as claimed in claim 10 wherein said operating time is limited to substantially no more than twice a time allowed for a valid acknowledgement of reception of said at least one packet of data less a time taken for said reconfiguring of said terminal from said first mode to said second mode and back.

12. A method as claimed in claim 10 wherein said operating time is limited to substantially no more than twice a time allowed for a valid acknowledgement of reception of said at least one packet of data less a time taken for said reconfiguring of said terminal from said first mode to said second mode and back and less a time taken for said receiving of said at least one packet of data.

13. A method of operating a reconfigurable radio packet data communications terminal, the method comprising:
operating said terminal in a first mode;
reconfiguring said terminal to a second mode of operation;
operating said terminal in said second mode of operation;
reconfiguring said terminal back to said first mode of operation; and
wherein said operating in said second mode is limited to substantially no more than twice a time allowed for valid acknowledgement of a reception of a packet data communication by said terminal less a time taken for said reconfiguring of said terminal from said first mode to said second mode and back.

14. A method of using a reconfigurable terminal of a wireless packet data communications network to create a time window to enable alternative mode monitoring, the method comprising omitting to transmit from the terminal an acknowledgement signal for a packet data communication to force retransmission of the packet data communication, to create said time window for reconfiguring said terminal to enable said alternative mode monitoring.

15. A method of operating a reconfigurable radio packet data communications terminal, the method comprising:
sending at least one first packet of data from the terminal to a data receiver using a first mode of operation of the terminal;
reconfiguring said terminal to a second mode of operation;
operating said terminal in said second mode of operation;
reconfiguring said terminal back to said first mode of operation; and
sending at least one second packet of data from the terminal to said data receiver using said first mode of operation; and
timing said operating such that said at least one first packet and said at least one second packet are sent with an interval substantially no greater that a time allowed for acknowledgement of valid reception of said at least one first packet of data.

16. A method as claimed in claim 15 comprising:
operating said terminal in said second mode for a period substantially no greater that a time allowed for acknowledgement of valid reception of said at least one first packet of data less a time taken for said reconfiguring of said terminal from said first mode to said second mode and back.

17. A method of using a reconfigurable terminal of a wireless packet data communications network to create a time window to enable alternative mode monitoring, the method comprising omitting to transmit a packet data communication from the terminal to create said time window for reconfiguring said terminal to enable said alternative mode monitoring.

18. A method as claimed in claim 17 further comprising retransmitting said packet data communication following reconfiguring of said terminal from a first mode of operation to an alternative mode of operation and back to said first mode.

19. A wireless communications terminal configured to operate in accordance with the method of any one of claims 1, 8, 13, 14, 15 and 17.

20. Processor control code to, when running, control a terminal to operate in accordance with the method of any one of claims 1, 8, 13, 14, 15 and 17.

21. A carrier carrying processor control code to, when running, control a terminal to operate in accordance with the method of any one of claims 1, 8, 13, 14, 15 and 17.
